(19) United States
(12) Patent Application Publication
(10) Pub. No.: US 2022/0122290 A1
(43) Pub. Date: Apr. 21, 2022

(54) Visual Line Analysis Apparatus, Visual Line Analysis Method, and Visual Line Analysis System

(71) Applicant: Hitachi, Ltd., Tokyo (JP)

(72) Inventors: Taku Kumon, Tokyo (JP); Riu Hirai, Tokyo (JP); Keiki Nakamura, Tokyo (JP)

(21) Appl. No.: 17/450,723

(22) Filed: Oct. 13, 2021

(30) Foreign Application Priority Data
Oct. 16, 2020 (JP) 2020-174916

(51) Int. Cl. G06T 7/73; G06K 9/46; G06K 9/00; G06K 9/20

(52) U.S. Cl. CPC G06T 7/74; G06K 9/4604; G06T 2207/30204; G06K 9/00604; G06K 9/2063; G06K 9/00671

(57) ABSTRACT

Provided are: an extraction unit extracting a plurality of sets of combinations of planes and coordinates corresponding to a plurality of objects from among images of the respective objects belonging to image information, based on the image information including the respective images of the plurality of objects which are images in a front direction of a worker; a plane selection unit selecting a designated set from among the plurality of sets of combinations of planes and coordinates extracted by the extraction unit according to a rule in which a priority for a plane corresponding to each object is defined; and an analysis unit calculating a gaze point coordinate indicating a gaze point of the worker based on visual line information indicating a visual line position of the worker and information on a combination of a plane and a coordinate belonging to the designated set selected by the plane selection unit.

### BACKGROUND OF THE INVENTION

### 1. Field of the Invention

The present invention relates to a visual line analysis apparatus, a visual line analysis method, and a visual line analysis system for analyzing a visual line of a worker.

### 2. Description of the Related Art

In recent years, the ratio of inexperienced workers, such as foreign workers, has increased along with a decrease in the domestic worker population in production sites of factories, but the number of skilled workers has decreased due to aging of skilled workers, so that workers are diversified and the productivity of the workers varies. Under the above environment, there is a need for a support mechanism that identifies bottlenecks of the respective workers and compensates for differences in variations of productivity among the respective workers.

There is a gazing place identification method based on information of a camera that outputs an image in a front direction of a worker and a wearable visual line camera that outputs coordinates of a visual line position as a measure for identifying a situation with which the worker lags as the bottleneck or a situation in which correct information is not acquired, from visual information. In order to identify the gazing place for grasping the situation of the worker in detail, for example, it is necessary to identify a gaze point in a coordinate system of an object that realizes high-accuracy identification such as “looking at which position inside a display” and “looking at which position of a tool” instead of coarse resolution such as “looking at a display now” and “looking at a tool”.

As an example of a background art for achieving the above, for example, JP 2015-219892 A describes a system that creates a heat map suitable to confirm how an object looks in comparison with a field of view of a viewer. In this system, acquisition of a browsed image and a gaze point of the viewer, extraction of a feature point in the browsed image, acquisition of a reference image feature point of the object, creation of a coordinate transformation matrix from the browsed image to a reference image, and calculation of a gaze corresponding point on the reference image are performed.

### SUMMARY OF THE INVENTION

In order to identify a gaze point with high accuracy, it is necessary to output a gaze point on a plane defined by each object as coordinate information. The identification of the gazing place in the coordinate system of the object requires five steps: (1) a step of acquiring a visual line position of a worker by a sensor in an inward direction of a wearable visual line sensor; (2) a step of acquiring an image of the worker in a front direction by a camera; (3) a step of detecting a plane and coordinate information corresponding to an object from the image of the camera; (4) a step of deriving a coordinate transformation operator from the detected plane and coordinate information; and (5) a step of transforming the visual line position of the worker into a visual line position in the coordinate system of the object based on the coordinate transformation operator and the visual line position of the worker.

Here, if a plurality of objects are reflected in the image for the steps (3), (4), and (5), sets of planes and pieces of coordinate information are detected as many as the number of objects in the step (3). Then, processing is performed by the number detected in step (3) in steps (4) and (5).

As a specific processing example, in an example in which processes of the steps (3), (4), and (5) are performed by a notebook personal computer (PC) using a QR marker, OpenCV.ArUco, cv2.findHomography, and cv2.perspectiveTransform, the step (4) becomes the process as a bottleneck. The processing performance in a case where there is one object reflected in an image is about 20 frames per second (fps). However, when ten objects are reflected in an image, the processes of steps (4) and (5) are performed ten times, and thus, the processing performance is reduced to about 6 fps. In actual work environments of factories, for example, there are many objects such as a display of a device, a controller, a workpiece, a tool, a work procedure manual, and the like, and thus, the processing performance may deteriorate due to a plurality of objects reflected in an image.

In addition, processing in an edge terminal characterized by low delay and low cost is advantageous in order to utilize a processing result for real-time support. However, in a case where a large number of objects are reflected due to a limited resource problem, it is impossible to implement the processes of the steps (4) and (5) at a high speed by the number of objects.

JP 2015-219892 A satisfies the point that the visual line position acquired by the wearable visual line sensor is transformed into coordinates of a reference image, but does not assume definition and extraction of a plurality of planes such as planes having different depths and planes having different orientations, and thus, it is difficult to achieve both the gazing place extraction processing with high accuracy and the real-time analysis processing.

An object of the present invention is to make a processing amount of information for identifying a gaze point of a worker constant regardless of the number of objects in an image.

In order to solve the above problems, the present invention includes: an extraction unit that extracts a plurality of sets of combinations of planes and coordinates corresponding to a plurality of objects from among images of the respective objects belonging to image information, based on the image information including the respective images of the plurality of objects, the images being images in a front direction of a worker; a plane selection unit that selects a designated set from among the plurality of sets of combinations of planes and coordinates extracted by the extraction unit according to a rule in which a priority for a plane corresponding to each of the objects is defined; and an analysis unit that calculates a gaze point coordinate indicating a gaze point of the worker based on visual line information indicating a visual line position of the worker and information on a combination of a plane and a coordinate belonging to the designated set selected by the plane selection unit.

According to the present invention, the processing amount of information for identifying the gaze point of the worker can be made constant regardless of the number of objects in the image. Other objects, configurations, and effects which have not been described above will become apparent from an embodiment to be described hereinafter.

### BRIEF DESCRIPTION OF THE DRAWINGS

FIG. 1 is an overall configuration diagram illustrating a system configuration example of a visual line analysis system according to an embodiment of the present invention;

FIG. 2 is a configuration diagram illustrating a hardware configuration example of an information processing apparatus according to the embodiment of the present invention;

FIG. 3 is a configuration diagram illustrating a configuration example of a plane and coordinate management table according to the embodiment of the present invention;

FIGS. 4A and 4B are configuration diagrams illustrating configuration examples of a priority table according to the embodiment of the present invention;

FIG. 5 is an explanatory diagram illustrating processing examples of an extraction unit and a plane selection unit according to the embodiment of the present invention;

FIG. 6 is an explanatory diagram illustrating a processing example using a marker in the analysis unit according to the embodiment of the present invention;

FIG. 7 is a configuration diagram illustrating a display example of a plane and coordinate management table setting screen according to the embodiment of the present invention;

FIG. 8 is a configuration diagram illustrating a display example of a plane and marker setting screen according to the embodiment of the invention;

FIG. 9 is a configuration diagram illustrating a display example of a priority table setting screen according to the embodiment of the present invention; and

FIG. 10 is a flowchart illustrating a processing example of the information processing apparatus according to the embodiment of the present invention.

### DESCRIPTION OF THE PREFERRED EMBODIMENTS

Hereinafter, an embodiment of the invention will be described with reference to the drawings.

### First Embodiment

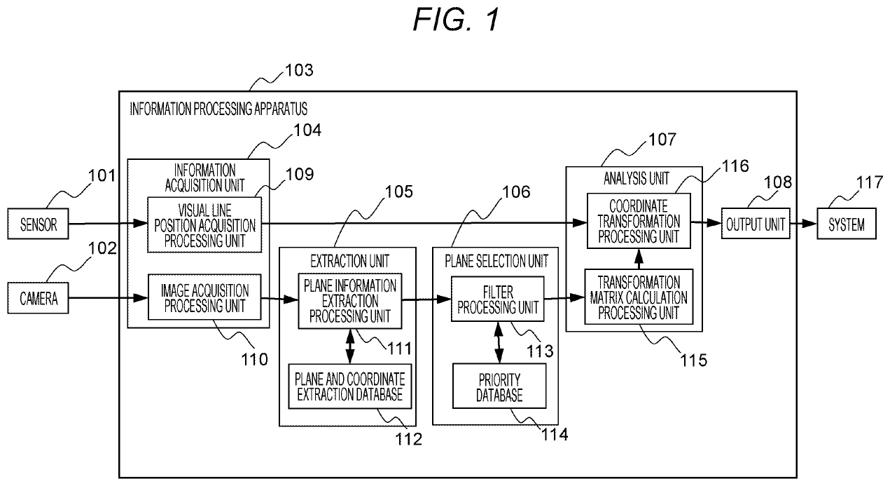

FIG. 1 is an overall configuration diagram illustrating a system configuration example of a visual line analysis system according to an embodiment of the present invention. In FIG. 1, the visual line analysis system includes a sensor 101, a camera 102, and an information processing apparatus 103. The sensor 101 is a sensor that outputs visual line information indicating a position of a visual line of a worker. The camera 102 is a camera that outputs image information including image data or the like indicating images of a plurality of objects which are images in a front direction of the worker and are subjects of the camera 102. The sensor 101 and the camera 102 are connected to the information processing apparatus 103 via a (wired or wireless) network, such as a local area network (LAN) and a wide area network (WAN), so as to enable communication. The information processing apparatus 103 receives information (visual line information and image information) from the sensor 101 and the camera 102, processes the visual line information and the image information, and analyzes the visual line of the worker.

The sensor 101 and the camera 102 exist, for example, in a production work site of a factory, and the information processing apparatus 103 exists, for example, in a production work site of a factory or in a cloud environment. The sensor 101 is, for example, a wearable visual line sensor that can detect a direction of the visual line of the worker by a corneal reflection method or a camera that captures a face of the worker in order to acquire an image used for inference of the direction of the visual line by image analysis. The camera 102 is, for example, a camera that is worn on the head or chest of the worker and can acquire the image in the front direction of the worker, or a camera attached to the wearable visual line sensor which is an example of the sensor 101.

Although one sensor 101 and one camera 102 are illustrated, there may be a plurality of the sensors 101 and a plurality of the cameras 102, and the respective sensors may be connected to the information processing apparatus 103 so as to enable communication. In addition, there may be also a plurality of the information processing apparatus 103 having similar functions according to the necessity such as a calculation processing condition and a location condition such as an edge and a cloud.

The information processing apparatus 103 internally includes, for example, an information acquisition unit 104, an extraction unit 105, a plane selection unit 106, an analysis unit 107, and an output unit 108 as visual line analysis apparatuses. The information acquisition unit 104 internally includes a visual line position acquisition processing unit 109 and an image acquisition processing unit 110, the extraction unit 105 internally includes a plane information extraction processing unit 111 and a plane and coordinate extraction database 112, the plane selection unit 106 internally includes a filter processing unit 113 and a priority database 114, and the analysis unit 107 internally includes a transformation matrix calculation processing unit 115 and a coordinate transformation processing unit 116.

In the information acquisition unit 104, the image acquisition processing unit 110 acquires the image information including the images of the plurality of objects as the images in the front direction of the worker from the camera 102, and the visual line position acquisition processing unit 109 acquires the visual line information of the worker from the sensor 101. Pieces of the acquired information are time-synchronized by the information acquisition unit 104. In a case where the sensor 101 and the camera 102 are time-synchronized before the information acquisition, a time stamp thereof may be used.

Here, the visual line position acquisition processing unit 109 acquires a visual line position of the worker at coordinates of the image of the camera 102 (coordinates on a camera image). Specifically, in a case where a Full HD (1920×1080) image is acquired from the sensor 101 by the visual line position acquisition processing unit 109 and the visual line of the worker is directed straight forward, the visual line information indicating the position of the visual line of the worker is acquired, for example, as (x=960, y=540). In order to satisfy the above, for example, in a case where the sensor 101 and the camera 102 are independent devices, calibration processing is performed to associate the visual line information with coordinates in the image of the camera 102. In a case where the visual line sensor using the corneal reflection method is not used as the sensor 101 and, for example, a face image of the worker is acquired, the visual line position acquisition processing unit 109 first performs image inference processing for estimation of the direction of the visual line.

The image information (image data) acquired by the image acquisition processing unit 110 is transmitted to the extraction unit 105, and the visual line information acquired by the visual line position acquisition processing unit 109 is transmitted to the analysis unit 107.

In the extraction unit 105, the image information (image data) including the image in the front direction of the worker transmitted from the image acquisition processing unit 110 inside the information acquisition unit 104 is collated with data (image data) stored in the plane and coordinate extraction database 112, so that the plane information extraction processing unit 111 extracts plane information and coordinate information corresponding to all the objects reflected in the image in the front direction of the worker.

Specifically, for example, in a case where three objects of a display, a controller, and a cubic box are reflected in an image, the plane information extraction processing unit 111 extracts planes (for example, one by one) in contact with the respective objects and coordinates (coordinate axes) defined in advance as a set based on information of the plane and coordinate extraction database 112 defined in advance. That is, three sets of information in which a plane and coordinate are paired are extracted in this example. Information on all the extracted combinations of planes and coordinates is transmitted to the plane selection unit 106.

Note that planes are in contact with the object one by one in the above example, but this is not necessarily applied. In a case where three objects of a display, a controller, and a cubic box are reflected in an image, one or more planes in contact with the cubic box are conceivable. Thus, for example, five combinations of planes and coordinates may be extracted by combining “display, controller, cubic box (top surface), cubic box (vertical surface), and cubic box (horizontal surface)”. The accuracy of the gaze point coordinate (visual line gaze point) output by the output unit 108 is improved by defining many planes, but the amount of information registered in the plane and coordinate extraction database 112 and the time and effort for registration are also increased.

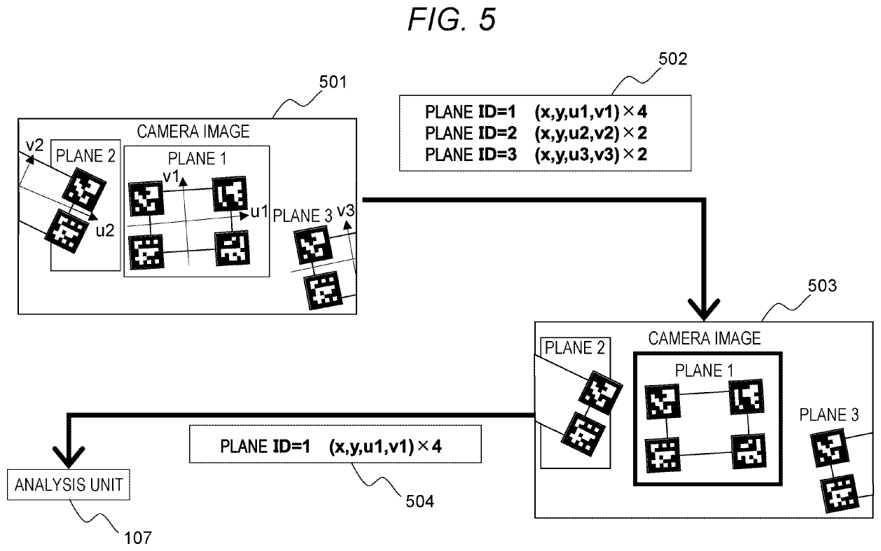

In addition, an extraction method of the plane information in the plane information extraction processing unit 111 can be realized by performing marker extraction processing using information on a corresponding plane and a marker whose coordinate value on the plane is defined (a specific example will be described later with reference to FIG. 5). Note that the marker is not necessarily used as the extraction method, and a markerless extraction method may be used. Specifically, for example, a teacher image of an object and a coordinate of a feature point in the teacher image are registered in advance in the plane and coordinate extraction database 112, and a combination of a plane and a coordinate corresponding to the object can be extracted by performing extraction processing by image inference using artificial intelligence (AI). Compared with the marker processing, it is considered that the markerless processing has advantages that “It is possible to save the time and effort for marker installation. There is no risk that the visual line of the worker approaches the marker.” and has a disadvantage of “A risk that the amount of calculation increases due to image inference and affects high-speed inference.”

In the plane selection unit 106, the filter processing unit 113 selects a designated set as a combination of a plane and a coordinate based on a rule of the priority database 114 (a rule in which priorities for the planes corresponding to the respective objects are defined) from among all the combinations of planes and coordinates transmitted from the plane information extraction processing unit 111 inside the extraction unit 105. At this time, the plane selection unit 106 functions as a plane selection unit that selects the designated set from among the plurality of sets of combinations of planes and coordinates extracted by the extraction unit 105 according to the rule in which the priorities for the planes corresponding to the respective objects are defined. Specifically, for example, in a case where priorities of all registered planes are recorded in a predefined priority table in the priority database 114, the filter processing unit 113 of the plane selection unit 106 refers to the priority table to select a set of a combination of a plane and a coordinate with the highest priority from among all the combinations of planes and coordinates transmitted from the plane information extraction processing unit 111. Information on the combination of the plane and coordinate selected by the filter processing unit 113 is transmitted to the analysis unit 107.

As a result, the set of pieces of information indicating the combination of the plane and coordinate with the highest priority is transmitted to the analysis unit 107, and thus, the amount of calculation in the analysis unit 107 becomes a constant amount without depending on the number of objects reflected in the image of the camera 102, and high-speed analysis can be realized.

Note that the rule of the priority database 114 does not necessarily follow the predefined priority table as in the above example. Examples of the rule include “select a plane closest to the center of the image of the camera 102”, “select a plane in the image closest to a visual line direction of the worker based on the visual line information from the sensor 101”, “select a plane having the largest number of markers or feature points extracted by the extraction unit 105”, “refer to the predefined priority table in the priority database 114 and select a plane with the highest priority from among planes reflected in the image (the above example)”, and the like. At this time, for example, when the designated set is selected, the plane selection unit 106 can adopt any one rule from among a first rule in which a plane located at the center of the image belonging to the image information is set as a plane with the highest priority, a second rule in which a plane present at a position closest to a visual line position of the worker is set as a plane with a high priority, and a third rule in which priority levels for the plurality of planes corresponding to the plurality of objects are defined by one priority table or two or more priority tables.

As another rule using the priority table, for example, a plurality of priority tables corresponding to pieces of work situation information indicating work situations may be set, and “a priority table to be referred may be switched based on a visual line analysis result obtained by the visual line analysis system”, or “a priority table to be referred may be switched based on a determination result of the work situation of the worker obtained by a cloud or another edge processing system”.

For example, when a work of a machining worker including setting before machining and a main machining process is assumed, for example, a priority table in which a controller or a work procedure manual for inputting a setting value has a higher priority is used first. As an increase in the number of rotations of a main spindle of a machining machine is detected by another edge processing system connected to the machining machine, it is determined that a work situation has been switched to the main machining process, and switching is performed to a priority table in which a display to which a mechanical load is output or a cut surface of a workpiece has a higher priority. When a mechanism for switching the priority according to the work situation information is provided in this manner, an appropriate object is easily selected even if the work is changed, and the accuracy of the gaze point coordinate (visual line gaze point) is improved. Note that priority levels for the plurality of planes corresponding to the plurality of objects are stored as information, such as numbers, in the plurality of priority tables.

In addition, the filter processing unit 113 in the plane selection unit 106 does not necessarily select only one combination of the plane and coordinate. Two or more combinations of planes and coordinates may be selected as necessary although caution is required if many combinations of planes and coordinates are selected because the amount of calculation in the analysis unit 107 increases.

In the analysis unit 107, the transformation matrix calculation processing unit 115 calculates a transformation matrix for performing coordinate transformation of a point on the image in the front direction of the worker acquired by the information acquisition unit 104 into a point on a plane corresponding to an object based on information on the combination of the plane and the coordinate (set of pieces of information indicating the combination of the plane and the coordinate with the highest priority) transmitted from the filter processing unit 113 inside the plane selection unit 106. In the related art, this transformation matrix processing is a bottleneck, and there is a problem that the processing time increases as the number of objects increases. In the visual line analysis system according to the embodiment, however, the processing amount in the analysis unit 107 becomes constant by the filter processing in the plane selection unit 106, and the processing time is reduced regardless of whether or not a large number of objects are reflected in the image captured by the camera 102.

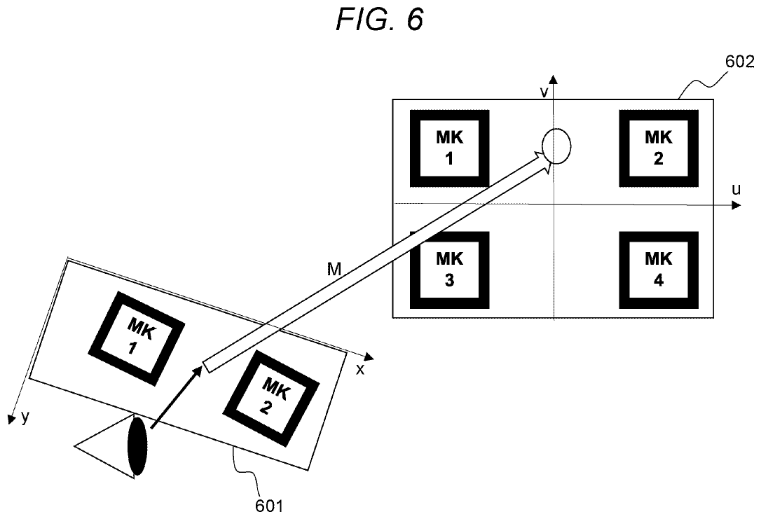

In the analysis unit 107, the coordinate transformation processing unit 116 transforms a visual line position in coordinates of the image in the front direction of the worker into a visual line position in coordinates of the plane corresponding to the object based on the transformation matrix calculated by the transformation matrix calculation processing unit 115 and the visual line information acquired by the information acquisition unit 104, and outputs information indicating the gaze point coordinates of the worker on the plane corresponding to the object. A specific processing example will be described later with reference to FIG. 6. The transformed result is transmitted to the output unit 108.

The output unit 108 outputs the information indicating the gaze point coordinates of the worker on the plane corresponding to the object transmitted from the coordinate transformation processing unit 116 inside the analysis unit 107. The output unit 108 outputs the information to, for example, the system 117 connected so as to enable communication. As the system 117, for example, a support system that realizes real-time support based on the information of the output unit 108, a worker's visual line situation recording system that writes data in a comma separated values (csv) file or the like for offline analysis or recording, and the like can be used. Note that the system 117 can also be arranged inside the information processing apparatus 103. In addition, the output unit 108 can be also configured using, for example, a display that displays an image of an analysis result of the analysis unit 107, a speaker that outputs the analysis result of the analysis unit 107 by voice, or projection mapping (projection device) that projects the analysis result of the analysis unit 107 on a building, an article, or the like.

Note that the plane and coordinate extraction database 112 and the priority database 114 are non-transitory or transitory recording media that store various programs and data. Examples of the plane and coordinate extraction database 112 and the priority database 114 include a read only memory (ROM), a random access memory (RAM), a hard disk drive (HDD), and a flash memory. Although the description has been given assuming that the plane and coordinate extraction database 112 and the priority database 114 are present inside the information processing apparatus 103, but these may be present outside the information processing apparatus 103.

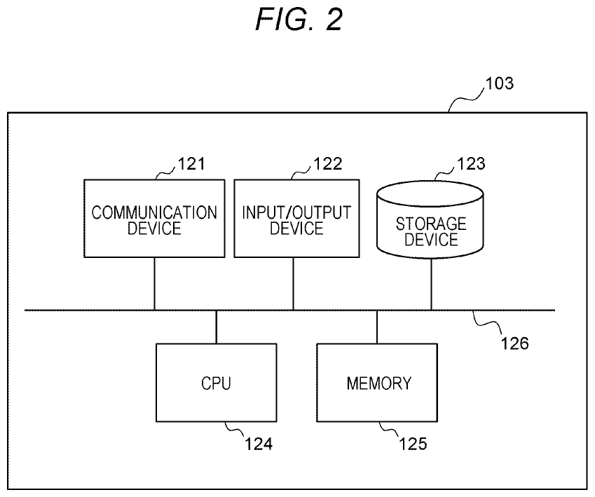

FIG. 2 is a configuration diagram illustrating a hardware configuration example of the information processing apparatus according to the embodiment of the present invention. In FIG. 2, the information processing apparatus 103 is configured using a computer device including a communication device 121, an input/output device 122, a storage device 123, a central processing unit (CPU) 124, and a memory 125, and the communication device 121, the input/output device 122, the storage device 123, the CPU 124, and the memory 125 are connected to each other via a bus 126.

The communication device 121 includes, for example, a network interface card (NIC) for connection to a wireless LAN or a wired LAN. The input/output device 122 is configured using an input device including a keyboard or a mouse and an output device including a display or a printer. The storage device 123 includes a storage medium such as a RAM and a ROM. The CPU 124 is configured as a central processing unit that integrally controls the operation of the entire information processing apparatus.

At this time, various computer programs are stored in the storage device 123. The respective computer programs are programs for causing the CPU 124 to function as the information acquisition unit 104, the extraction unit 105, the plane selection unit 106, the analysis unit 107, and the output unit 108. An information processing acquisition program that functions as the information acquisition unit 104 includes a visual line position acquisition processing program that causes the CPU 124 to function as the visual line position acquisition processing unit 109 and an image acquisition processing program that causes the CPU 124 to function as the image acquisition processing unit 110. An extraction program that functions as the extraction unit 105 includes a plane information extraction processing program that causes the CPU 124 to function as the plane information extraction processing unit 111. A plane selection program that functions as the plane selection unit 106 includes a filter processing program that causes the CPU 124 to function as the filter processing unit 113. The plane and coordinate extraction database 112 of the extraction unit 105 and the priority database 114 of the plane selection unit 106 are stored in the storage device 123. In a case where the system 117 is arranged inside the information processing apparatus 103, the function of the system 117 can be configured using a program to be processed by the CPU 124, and the program can be stored in the storage device 123.

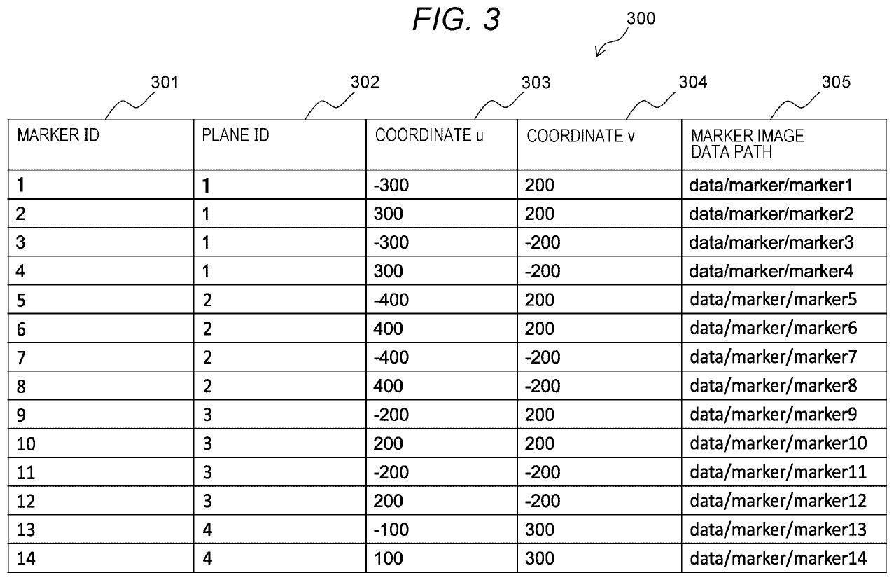

FIG. 3 is a configuration diagram illustrating a configuration example of a plane and coordinate management table according to the embodiment of the present invention. In FIG. 3, the plane and coordinate management table 300 is a table stored in the plane and coordinate extraction database 112 as a table for managing data recorded in the plane and coordinate extraction database 112, and includes a marker ID 301, a plane ID 302, a coordinate u 303, a coordinate v 304, and a marker image data path 305.

The marker ID 301 stores information on an identifier for uniquely identifying a marker present in an image transmitted from the information acquisition unit 104, for example, a numerical value indicating a number. The plane ID 302 stores information on an identifier uniquely identifying a plane belonging to the marker present in the image transmitted from the information acquisition unit 104, for example, a numerical value indicating a number. The coordinate u 303 stores information on a coordinate indicating a position of the marker on the plane (position in a horizontal direction u), and the coordinate v 304 stores information on a coordinate indicating a position of the marker on the plane (position in a vertical direction v). The marker image data path 305 stores information indicating a data path of the marker present in the image transmitted from the information acquisition unit 104. At this time, the extraction unit 105 stores, as an access target, the plane and coordinate management table 300 in which a plurality of planes belonging to an image of image information, coordinates of the plurality of planes, and a plurality of markers added to the respective planes are recorded in association with a plurality of data paths for identifying the respective markers. These pieces of information are manually recorded in the plane and coordinate management table 300 in advance. Note that it is also possible to adopt a configuration in which the information recorded in the plane and coordinate management table 300 is appropriately and automatically corrected based on an analysis result of the information processing apparatus 103. Specifically, for example, a program for correcting distortion based on marker extraction processing after manually setting the coordinate u and the coordinate v may be implemented, and the information of the plane and coordinate management table 300 may be automatically corrected by the processing of the program.

The plane and coordinate management table 300 is managed as the access target of the plane information extraction processing unit 111. At this time, the plane information extraction processing unit 111 refers to the plane and coordinate management table 300 based on the image information transmitted from the information acquisition unit 104, performs matching processing between a marker image present in the marker image data path 205 and the image transmitted from the information acquisition unit 104, and extracts information of the marker ID 301 present in the image from the image identified by the image information transmitted from the information acquisition unit 104. Next, the plane information extraction processing unit 111 refers to the plane and coordinate management table 300 and extracts information related to the plane ID 302 to which the marker ID 301 belongs, the coordinate u 303, and the coordinate v 304. Thereafter, the plane information extraction processing unit 111 transmits the extracted information, for example, information including “plane ID, (coordinates u and v, marker positions x and y in image)×marker” as a set, to the plane selection unit 106 as many as the number of plane IDs. At this time, when receiving the image information, the extraction unit 105 refers to the plane and coordinate management table 300 based on a data path (the marker image data path 205) added to the image information, and extracts a plurality of sets of combinations of planes and coordinates corresponding to the marker identified by the data path.

Note that the example in which the information is extracted from the plane and coordinate management table 300 using the marker has been described as the extraction method in the plane information extraction processing unit 111. In the markerless case, however, as the extraction method in the plane information extraction processing unit 111, the “marker ID” and the “marker image data path” may be changed to a “feature point ID” and a “plane image data path”, respectively, regarding the plane and coordinate management table 300, image inference by AI may be performed based on an image of the plane image data path, and processing of extraction of a plane image and extraction of a feature point may be performed.

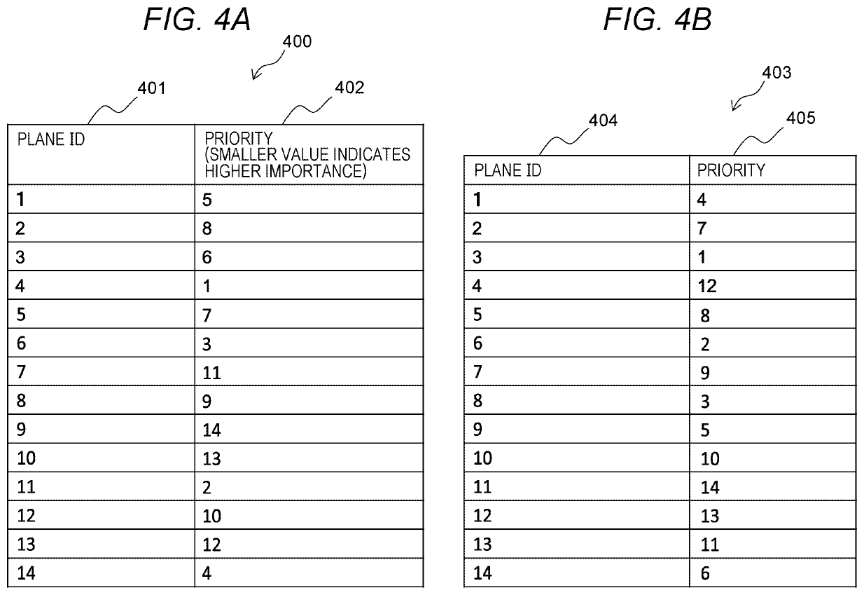

FIGS. 4A and 4B are configuration diagrams illustrating configuration examples of the priority table according to the embodiment of the present invention. In FIG. 4A, the priority table 400 is a table stored in the priority database 114 as a table for managing data recorded in the priority database 114, and includes a plane ID 401 and a priority (smaller value indicates higher importance) 402. The plane ID 401 stores information similar to the information recorded in the plane ID 302 of the plane and coordinate management table 300. The priority (smaller value indicates higher importance) 402 stores information for identifying a priority of a plane as, for example, a numerical value indicating a number. At this time, the smaller the numerical value of the number, the higher the priority. These pieces of information are manually recorded in the priority table 400 in advance. Note that the information recorded in the priority table 400 can be appropriately and automatically corrected based on a processing result of the information processing apparatus 103. Specifically, for example, a program for performing correction to increase a priority of a plane to be frequently observed after manually setting after the priority 402 may be implemented, and the information in the priority table 400 may be automatically corrected by the processing of the program.

The priority table 400 is referred to when the filter processing unit 113 selects one combination (not necessarily one combination) of a plane and coordinate with a high priority. Specifically, the filter processing unit 113 refers to the priority table 400 based on the information transmitted from the plane information extraction processing unit 111 of the extraction unit 105, selects a plane having the highest priority from among plane IDs existing in the image and transmitted from the extraction unit 105, and transmits information on the selected plane with the highest priority and a coordinate corresponding to the plane to the analysis unit 107. Note that the number of the priority tables 400 is not necessarily one. For example, in a case where the priority table 400 is a table of “Work Situation 1”, a priority table 403 of “Work Situation 2” can also be used as illustrated in FIG. 4B.

The priority table 403 is a table stored in the priority database 114 as a table for managing data recorded in the priority database 114, and includes a plane ID 404 and a priority 405. The plane ID 404 stores information similar to the information recorded in the plane ID 302 of the plane and coordinate management table 300. The priority 405 stores information for identifying a priority of a plane as, for example, a numerical value indicating a number. At this time, the smaller the numerical value of the number, the higher the priority. These pieces of information are manually recorded in the priority table 400 in advance.

In the case where the priority tables 400 and 403 are used, the priority table to be referred to can be switched according to the work situation information indicating the work situation. Specifically, for example, the work situation may be determined by ab analysis result of the information processing apparatus 103, a cloud, or another edge processing system, and an appropriate one of the priority table 400 (Work Situation 1) and the priority table 403 (Work Situation 2) may be referred to based on the work situation information indicating the determination result. At this time, priority levels are set to different values based on the work situation information indicating the work situation of the worker for the respective planes in each of the priority tables 400 and 403, and the plane selection unit 106 selects one priority table between the plurality of priority tables 400 and 403 according to the work situation information. As a result, the filter processing unit 113 can select a plane having the highest priority according to the work situation, and transmit information regarding the selected plane and coordinate corresponding to the plane to the analysis unit 107.

FIG. 5 is an explanatory diagram illustrating processing examples of the extraction unit and the plane selection unit according to the embodiment of the present invention. In FIG. 5, when image information (image information including “Plane 1”, “Plane 2”, and “Plane 3”) including a camera image 501 captured by the camera 102 is input from the image acquisition processing unit 110 to the extraction unit 105, the plane information extraction processing unit 111 of the extraction unit 105 searches the plane and coordinate extraction database 112 based on the input image information, and refers to the plane and coordinate management table 300 to extract a marker belonging to the image information.

For example, in a case where markers (MK1 to MK4) of “Plane 1”, markers (MK6 and MK8) of “Plane 2”, and markers (MK9 and MK11) of “Plane 3” are present, as markers, in the camera image 501, the plane information extraction processing unit 111 extracts eight markers identified by “1, 2, 3, 4, 6, 8, 9, and 11” of the marker IDs 301. Since the marker ID 301 is associated with the plane ID 302, the coordinate u 303, and the coordinate v 304 in the plane and coordinate management table 300, “1, 2, and 3” are extracted as the plane IDs 302, and (−300, 200), (300, 200), (−300, −200), (300, −200), (400, 200), (400, −200), (−200, 200), and (−200, −200) are extracted as the coordinates u 303 and the coordinates v 304 corresponding to the respective markers. Plane information 502 in which these pieces of information are collected for each plane ID is transmitted from the extraction unit 105 to the plane selection unit 106 as, for example, information of “Plane ID=1, (x, y, coordinates u1 and v1)×4 sets”, “Plane ID=2, (x, y, coordinates u2 and v2)×2 sets”, and “Plane ID=3, (x, y, coordinates u3 and v3)×2 sets”. Note that (x, y) is a coordinate indicating a marker position of each marker in the image.

Note that the markers are not necessarily arranged in a square, rectangular, or the like. A marker may be pasted to an arbitrary position of the camera image 501, and an appropriate coordinate of the marker may be set in a table. In addition, the number of markers is not necessarily four per plane. When a large number of markers are arranged, the number of markers entering the camera 102 increases, so that there is an advantage that the position determination accuracy is improved, but there is also a disadvantage that the number of setting steps increases. In addition, it is unnecessary to make sizes of the markers uniform. When sizes of markers are small, there are advantages that it is easy to paste the markers on the camera image 501, the worker is hardly disturbed, and all the markers easily enter an imaging range of the camera 102, but there is also a disadvantage that the markers are not detected due to a problem of the resolution of the camera image 501 if the markers are separated distantly. Thus, an appropriate size may be used as necessary.

When the plane selection unit 106 receives the plane information 502 including the camera image 501 having the plane IDs “1, 2, and 3”, the filter processing unit 113 of the plane selection unit 106 searches the priority database 114 based on the received plane information 502 and refers to the priority table 400 to select one with the highest priority. For example, the filter processing unit 113 selects information of a camera image 503 identified by the plane ID=1 as the plane with the highest priority from among the plane IDs “1, 2, and 3”. In this case, only the information of “Plane ID=1, (x, y, u1, v1)×4 sets” is selected as selection information 504 as the information of “Plane 1”. Thereafter, the filter processing unit 113 transmits the selected selection information 504 to the analysis unit 107. In this case, the analysis unit 107 receives the selection information 504 of “Plane ID=1, (x, y, u1, v1)×4 sets”. In a case where the filter processing unit 113 refers to the priority table 403, the filter processing unit 113 selects information of the camera image 503 identified by the plane ID=3 (information of “Plane 3”) as one with the highest priority.

FIG. 6 is an explanatory diagram illustrating a processing example using the marker in the analysis unit according to the embodiment of the present invention. When the analysis unit 107 executes processing, first, the transformation matrix calculation processing unit 115 calculates a transformation matrix M for transforming coordinates of a camera image into coordinates of “Plane 1” based on the information (coordinates x and y in the camera image captured by camera 102) belonging to the selection information 504 transmitted from the plane selection unit 106 and the information on the coordinates (u, v) of a plane of an object (a capturing target of the camera 102), for example, “Plane 1”. The transformation matrix M is, for example, a two-dimensional matrix. Note that the calculation of the transformation matrix M requires a plurality of combinations of the coordinates x and y of a transformation source and the coordinates u and v of a transformation destination, but this does not necessarily require extraction of a plurality of markers.

Specifically, for example, in a case where information on four corners of a marker is registered instead of registering a center point per marker, four sets of (x, y, u, v) can be extracted as coordinates per marker. For example, in a case where two markers (“MK1” and “MK2”) are reflected in a camera image 601, the transformation matrix M can be derived using information of eight sets of coordinates (x, y, u, v). As the number of sets of coordinates (x, y, u, v) increases, the accuracy is improved, but the time and effort for inputting preset values increase. Thus, an optimum configuration may be selected as necessary.

Meanwhile, the coordinate transformation processing unit 116 of the analysis unit 107 receives the visual line information indicating the visual line position of the worker from the information acquisition unit 104, and receives the information of the transformation matrix M from the transformation matrix calculation processing unit 115. Coordinates belonging to the visual line information correspond to the coordinates (x, y) of each marker belonging to the camera image 601. The coordinate transformation processing unit 116 executes calculation according to the following Formula 1 based on the visual line information from the information acquisition unit 104 and the information of the transformation matrix M from the transformation matrix calculation processing unit 115, and calculates gaze point information 602 having coordinates on a target plane, for example, coordinates (u, v) on “Plane 1” as gaze point coordinates. As a result, it is possible to identify detailed coordinates as a point to be gazed in the object ahead of the visual line of the worker as the gaze point coordinates or coordinates belonging to a gazing region.

$$\begin{matrix}[ Formula 1 ] & \\ ( \begin{matrix}u \\ v\end{matrix} ) = M ( \begin{matrix}x \\ y\end{matrix} ) & ( 1 )\end{matrix}$$

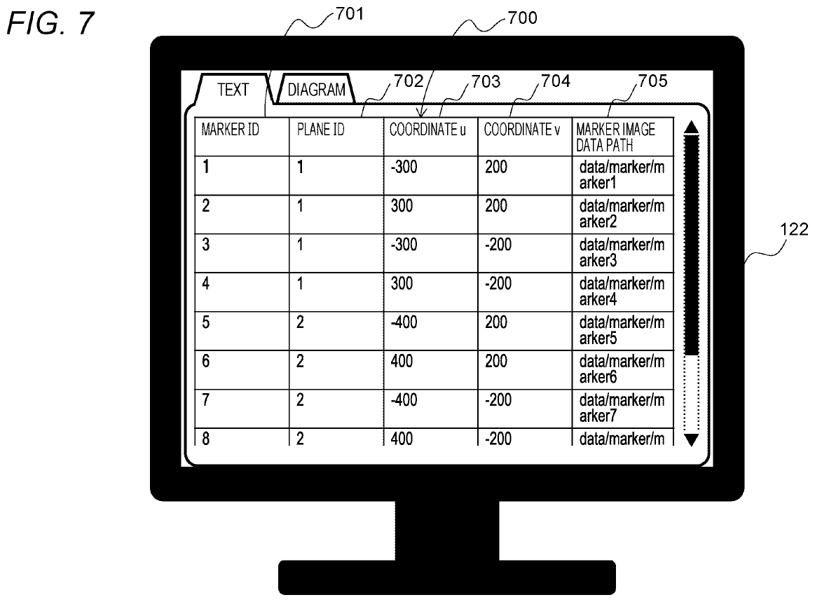

FIG. 7 is a configuration diagram illustrating a display example of a setting screen of the plane and coordinate management table according to the embodiment of the present invention. In FIG. 7, a plane and coordinate management table setting screen 700 is a screen of the input/output device 122, and includes a marker ID 701, a plane ID 702, a coordinate u 703, a coordinate v 704, and a marker image data path 705. In the plane and coordinate management table setting screen 700, the information of the plane and coordinate management table 300 is set in advance as information using text in order to perform the marker detection by the extraction unit 105 and the image inference by AI. Note that these pieces of information are set as an administrator inputs numerical values and characters.

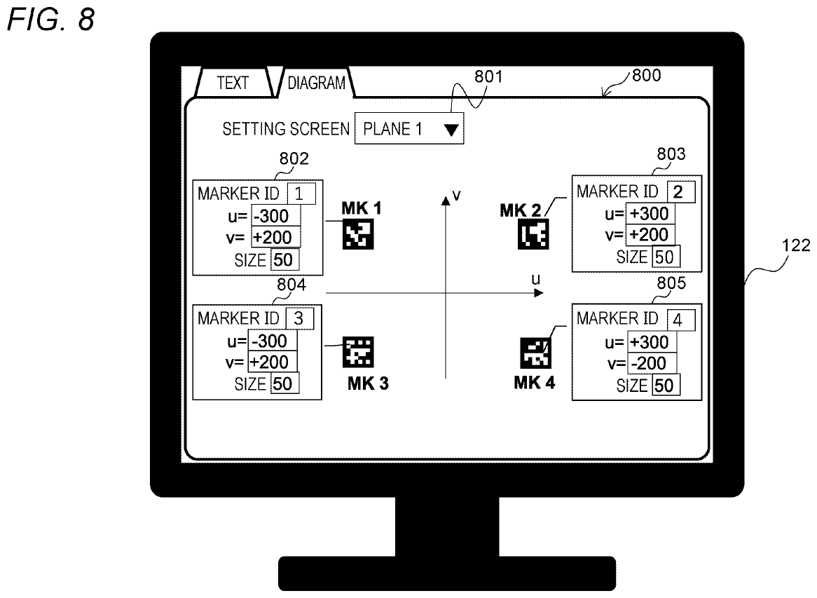

FIG. 8 is a configuration diagram illustrating a display example of a plane and marker setting screen according to the embodiment of the invention. In FIG. 8, a plane and marker setting screen 800 is a screen of the input/output device 122, and is configured using information of a diagram stored in the plane and coordinate extraction database 112. On the plane and marker setting screen 800, an input region 801 of the setting screen and input regions 802 to 805 of marker information (setting value information) are displayed. In each input region, information input by an operation of the administrator is displayed. For example, information of “Plane 1” is displayed in the input region 801 of the setting screen, and information of IDs of the respective markers (“MK1” to “MK4”), coordinates (u, v) of the respective markers, and information on sizes of the respective markers are displayed in the input region 802 to 805.

Note that a position or the like of the marker in the input information automatically moves to an appropriate coordinate based on the administrator's input operation. As a result, it is possible to visually recognize whether the setting is correct, so that an error in initial setting decreases. Since the setting can be performed visually, the burden on the administrator also decreases. The setting screen illustrated in FIG. 7 and the setting screen illustrated in FIG. 8 can be displayed in synchronization with each other. In addition, the setting of the size of each marker is advantageous when it is desired to input information on four coordinates per marker. Specifically, for example, if information on coordinates and a size of a center point of a marker is input, coordinates of four corners of the marker can be collectively set.

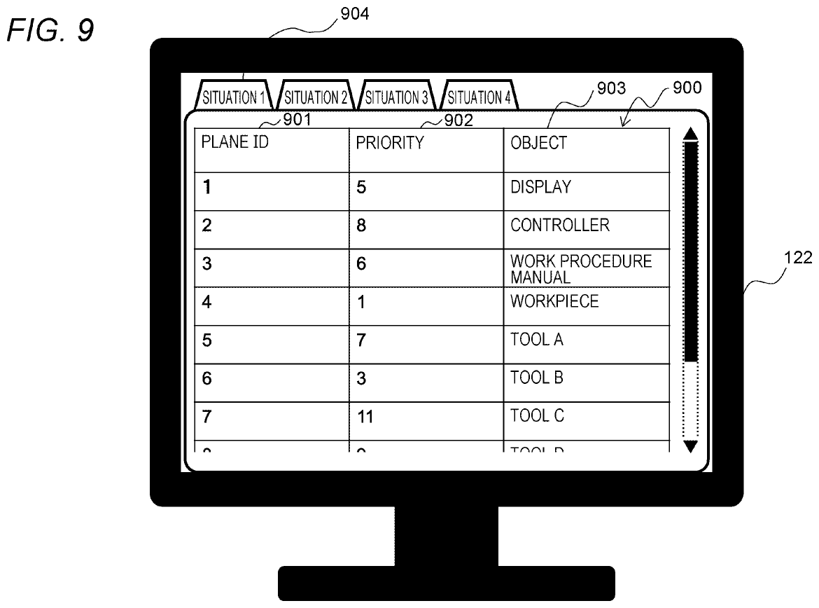

FIG. 9 is a configuration diagram illustrating a display example of a priority table setting screen according to the embodiment of the present invention. In FIG. 9, a priority table setting screen 900 is a screen of the input/output device 122, and includes a plane ID 901, a priority 902, and an object 903. For example, information of a numerical value indicating a number is input to the plane ID 901 as information of an identifier for identifying a plane. For example, information on a number whose numerical value is smaller as a priority is higher is input to the priority 902 as information indicating a priority of the plane. For example, information such as a “display”, a “controller”, and a “work procedure manual” is input to the object 903 as information for identifying an object of the camera 102. These pieces of information are set in advance for the plane selection unit 106 to perform the filtering processing. At this time, the setting is performed as the administrator inputs numerical values or characters.

Note that, in addition to the plane ID 901, there may be a row of the object 903 indicated by the plane ID 901 for easy understanding of a person. In a case where a priority table to be referred to is changed according to a situation, for example, “Situation 1” to “Situation 4”, there may be a setting screen indicating under which condition the priority table is switched. Specifically, it is possible to adopt a configuration in which the plane selection unit 106 switches a priority table to be referred to to a priority table of “Situation 1” in a case where there is an input indicating “Situation 1”, for example, by registering an input information destination link to determine “Situation 1” on the setting screen 900.

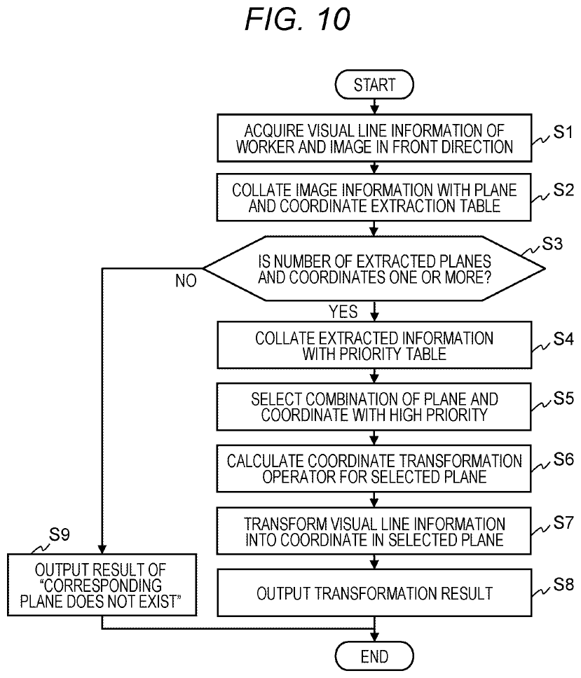

FIG. 10 is a flowchart illustrating a processing example of the information processing apparatus according to the embodiment of the present invention.

Step S1: In the information acquisition unit 104, the visual line position acquisition unit 109 acquires visual line information indicating a visual line position of a worker from the sensor 101, and the image acquisition processing unit 110 acquires image information including an image in a front direction of the worker from the camera 102. The visual line information and the image information are acquired by the information acquisition unit 104 at synchronized timings (in a time-synchronized manner). The visual line information acquired by the information acquisition unit 104 is transmitted from the information acquisition unit 104 to the analysis unit 107, and the image information acquired by the information acquisition unit 104 is transmitted from the information acquisition unit 104 to the extraction unit 105.

Step S2: The plane information extraction processing unit 111 of the extraction unit 105 searches the plane and coordinate extraction database 112 based on the image information (image data) received from the image acquisition unit 110, and collates the image (the image in the front direction of the worker) acquired by the image acquisition processing unit 110 with the plane and coordinate management table 300 stored in the plane and coordinate extraction database 112.

Step S3: The plane information extraction processing unit 111 of the extraction unit 105 determines whether the number of extracted planes and coordinates is one or more based on the collation result. At this time, the plane information extraction processing unit 111 extracts each information on the planes and coordinates corresponding to all the objects reflected in the image (the image in the front direction of the worker) acquired by the image acquisition processing unit 110, and transmits the extracted information on the planes and coordinates to the plane selection unit 106. When one or more pieces of information on the planes and coordinates are extracted in step S3, the processing proceeds to step S4, and otherwise, the processing proceeds to step S9.

Step S4: The filter processing unit 113 of the plane selection unit 106 collates information indicating all combinations of the planes and coordinates extracted by the plane information extraction processing unit 111 with information recorded in the priority table 400 stored in the priority database 114.

Step S5: The filter processing unit 113 of the plane selection unit 106 selects a combination of a plane and a coordinate with a high priority based on the collation result, and transmits information on the selected combination of the plane and coordinate with the high priority to the analysis unit 107.

Step S6: The transformation matrix calculation processing unit 115 of the analysis unit 107 calculates, as a coordinate transformation operator, the transformation matrix M that performs coordinate transformation of a point on the image in the front direction of the worker acquired by the information acquisition unit 104 into a point on the plane corresponding to the object based on the information on the combination of the plane and coordinate selected by the filter processing unit 113.

Step S7: The coordinate transformation processing unit 116 of the analysis unit 107 executes the calculation of Formula 1 based on the transformation matrix M calculated by the transformation matrix calculation processing unit 115 and the visual line information acquired by the information acquisition unit 104, transforms the visual line position of the worker in the coordinates of the image in the front direction into a visual line position in the coordinates of the plane corresponding to the object, and transmits information on the transformed visual line position to the output unit 108.

Step S8: The output unit 108 outputs a gaze point coordinate of the worker on the plane corresponding to the object as the transformation result transformed by the coordinate transformation processing unit 116 of the analysis unit 107, and ends the processing in this routine.

Step S9 (when the determination in step S3 is NO): The output unit 108 outputs a result of “corresponding plane does not exist”, which indicates that there is no corresponding plane, and ends the processing in this routine.

According to the present embodiment, the information processing apparatus 103 acquires pieces of information of the sensor 101 and the camera 102, extracts the combinations of planes and coordinates corresponding to all the objects in the image based on preset setting values of the database, and narrows down the combination of the plane and the coordinate to be transmitted to the analysis unit based on the predetermined priority. Therefore, it is possible to make the processing amount of information for identifying the gaze point of the worker constant without depending on the number of objects reflected in the image, and as a result, the high-speed calculation becomes possible.

According to the present embodiment, even in the case where the plurality of objects are reflected in the image in the front direction of the worker, the plane selection unit included in the information processing apparatus selects (for example, one set of) the combination of the plane and the coordinate by the filtering processing based on the priority. Therefore, the analysis processes of the steps (4) and (5) repeated as many times as the number of objects to be reflected, which is a problem of a conventional system, can be suppressed to the number of selected combinations (for example, once), so that the amount of calculation for the coordinate identification is not increased, and the calculation within the constant processing time independent of the number of objects becomes possible.

According to the present embodiment, it is possible to perform real-time analysis of the gazing place with high accuracy even in an edge terminal with low delay and low cost but limited resources, so that it is possible to provide accurate real-time support to the worker based on the analysis result.

As a result, the visual line analysis system enables the high-accuracy identification of the gaze point in the edge terminal with low delay and low cost but limited resources. Therefore, the visual line analysis system can provide a visual line information analysis technique at low cost using the edge terminal. In addition, the real-time support based on the information of the gaze point to the worker can be realized by utilizing the advantage of the low delay of the edge terminal and the advantage of the high-speed calculation of the visual line analysis system.

Incidentally, the present invention is not limited to the above-described embodiment, and may include various modifications and equivalent configurations that fall within the scope of the appended claims. For example, the above-described embodiment has been described in detail in order to describe the present invention in an easily understandable manner, and the present invention is not necessarily limited to one including the entire configuration that has been described above. For example, the present embodiment is described on the premise of implementation in the edge terminal, the implementation in the edge terminal is not necessarily required, and implementation may be performed using a high-performance server or cloud.

Further, each configuration, function, processing unit, processing means, and the like described above may be, partially or fully, implemented by hardware, for example, by designing it using an integrated circuit and the like, or implemented by software by causing the processor to interpret and execute a program that implements each function.

The information, such as a program, a table, and a file, to implement each function can be stored in a storage device, such as a memory, a hard disk, and an SSD (Solid State Drive), or a recording medium such as an integrated circuit (IC) card, an SD card, and a digital versatile disc (DVD).

What is claimed is:

1. A visual line analysis apparatus comprising:
an extraction unit that extracts a plurality of sets of combinations of planes and coordinates corresponding to a plurality of objects from among images of the respective objects belonging to image information, based on the image information including the respective images of the plurality of objects, the images being images in a front direction of a worker;
a plane selection unit that selects a designated set from among the plurality of sets of combinations of planes and coordinates extracted by the extraction unit according to a rule in which a priority for a plane corresponding to each of the objects is defined; and
an analysis unit that calculates a gaze point coordinate indicating a gaze point of the worker based on visual line information indicating a visual line position of the worker and information on a combination of a plane and a coordinate belonging to the designated set selected by the plane selection unit.

2. The visual line analysis apparatus according to claim 1, wherein
when the designated set is selected, the plane selection unit adopts any one rule among a first rule in which a plane located at a center of the image belonging to the image information is set as a plane with a highest priority, a second rule in which a plane present at a position closest to a visual line position of the worker is set as a plane with a high priority, and a third rule in which priority levels for the plurality of planes corresponding to the plurality of objects are defined by one priority table or two or more priority tables.

3. The visual line analysis apparatus according to claim 2, wherein
in each of the two or more priority tables, the priority levels are set to different values based on work situation information indicating work situations of the worker, respectively, for the plurality of planes, and
the plane selection unit selects one priority table from among the two or more priority tables according to the work situation information.

4. The visual line analysis apparatus according to claim 1, wherein
the extraction unit
stores, as an access target, a plane and coordinate management table in which a plurality of planes belonging to an image of the image information, coordinates of each of the plurality of planes, and a plurality of markers added to each of the planes are recorded in association with a plurality of data paths for identifying each of the plurality of markers, and
refers to the plane and coordinate management table based on the data path added to the image information when receiving the image information to extract a plurality of sets of a combination of the plane and coordinate corresponding to the marker identified by the data path.

5. The visual line analysis apparatus according to claim 1, wherein
the analysis unit calculates a transformation matrix for transforming a coordinate on an image in the image belonging to the image information into a coordinate on a plane in the plane of the designated set selected by the plane selection unit based on the image information and the information selected by the plane selection unit, and calculates the gaze point coordinate based on the calculated transformation matrix and the visual line information.

6. A visual line analysis method comprising:
an extraction step of extracting a plurality of sets of combinations of planes and coordinates corresponding to a plurality of objects from among images of the respective objects belonging to image information, based on the image information including the respective images of the plurality of objects, the images being images in a front direction of a worker;
a plane selection step of selecting a designated set from among the plurality of sets of combinations of planes and coordinates extracted in the extraction step according to a rule in which a priority for a plane corresponding to each of the objects is defined; and
an analysis step of calculating a gaze point coordinate indicating a gaze point of the worker based on visual line information indicating a visual line position of the worker and information on a combination of a plane and a coordinate belonging to the designated set selected in the plane selection step.

7. The visual line analysis method according to claim 6, wherein
in the plane selection step,
when the designated set is selected, any one rule is adopted among a first rule in which a plane located at a center of the image belonging to the image information is set as a plane with a highest priority, a second rule in which a plane present at a position closest to a visual line position of the worker is set as a plane with a high priority, and a third rule in which priority levels for the plurality of planes corresponding to the plurality of objects are defined by one priority table or two or more priority tables.

8. The visual line analysis method according to claim 7, wherein
in each of the two or more priority tables, the priority levels are set to different values based on work situation information indicating work situations of the worker, respectively, for the plurality of planes, and
in the plane selection step, one priority table is selected from among the two or more priority tables according to the work situation information.

9. The visual line analysis method according to claim 6, wherein
in the extraction step,
a plane and coordinate management table in which a plurality of planes belonging to an image of the image information, coordinates of each of the plurality of planes, and a plurality of markers added to each of the planes are recorded in association with a plurality of data paths for identifying each of the plurality of markers is stored as an access target, and
the plane and coordinate management table is referred to based on the data path added to the image information when receiving the image information to extract a plurality of sets of a combination of the plane and coordinate corresponding to the marker identified by the data path.

10. The visual line analysis method according to claim 6, wherein
in the analysis step,
a transformation matrix for transforming a coordinate on an image in the image belonging to the image information into a coordinate on a plane in the plane of the designated set selected in the plane selection step is calculated based on the image information and the information selected in the plane selection step, and the gaze point coordinate is calculated based on the calculated transformation matrix and the visual line information.

11. A visual line analysis system comprising:
a visual line sensor that outputs visual line information indicating a visual line position of a worker;
a camera that outputs image information including images of a plurality of objects as subjects, the images being images in a front direction of the worker; and
an information processing apparatus that receives and processes the visual line information output from the visual line sensor and the image information output from the camera,
wherein the information processing apparatus includes:
an extraction unit that extracts a plurality of sets of combinations of planes and coordinates respectively corresponding to the plurality of objects from among images belonging to the image information based on the image information;
a plane selection unit that selects a designated set from among the plurality of sets of combinations of planes and coordinates extracted by the extraction unit according to a rule in which a priority for a plane corresponding to each of the objects is defined; and
an analysis unit that calculates a gaze point coordinate indicating a gaze point of the worker based on the visual line information and information on a combination of a plane and a coordinate belonging to the designated set selected by the plane selection unit.

12. The visual line analysis system according to claim 11, wherein
when the designated set is selected, the plane selection unit adopts any one rule among a first rule in which a plane located at a center of the image belonging to the image information is set as a plane with a highest priority, a second rule in which a plane present at a position closest to a visual line position of the worker is set as a plane with a high priority, and a third rule in which priority levels for the plurality of planes corresponding to the plurality of objects are defined by one priority table or two or more priority tables.

13. The visual line analysis system according to claim 12, wherein
in each of the two or more priority tables, the priority levels are set to different values based on work situation information indicating work situations of the worker, respectively, for the plurality of planes, and
the plane selection unit selects one priority table from among the two or more priority tables according to the work situation information.

14. The visual line analysis system according to claim 11, wherein
the extraction unit
stores, as an access target, a plane and coordinate management table in which a plurality of planes belonging to an image of the image information, coordinates of each of the plurality of planes, and a plurality of markers added to each of the planes are recorded in association with a plurality of data paths for identifying each of the plurality of markers, and
refers to the plane and coordinate management table based on the data path added to the image information when receiving the image information to extract a plurality of sets of a combination of the plane and coordinate corresponding to the marker identified by the data path.

15. The visual line analysis system according to claim 11, wherein
the analysis unit calculates a transformation matrix for transforming a coordinate on an image in the image belonging to the image information into a coordinate on a plane in the plane of the designated set selected by the plane selection unit based on the image information and the information selected by the plane selection unit, and calculates the gaze point coordinate based on the calculated transformation matrix and the visual line information.
